(19) United States
(12) Patent Application Publication
(10) Pub. No.: US 2025/0251273 A1
(43) Pub. Date: Aug. 7, 2025

(54) DEVICE FOR WEIGHT MEASUREMENT FOR WEIGHING PROPORTION OF GRILLED FOOD, A DEVICE FOR PREPARING FOOD TO BE GRILLED, A METHOD FOR PREPARING FOOD TO BE GRILLED, AND A COMPUTER PROGRAM

(71) Applicant: Fatih Mehmet ÖNCEBE, Berlin (DE)

(72) Inventor: Fatih Mehmet ÖNCEBE, Berlin (DE)

(21) Appl. No.: 19/043,440

(22) Filed: Feb. 1, 2025

(30) Foreign Application Priority Data
Feb. 1, 2024 (EP) 24155317

(51) Int. Cl. G01G 19/414; A47J 36/00; A47J 37/04; G01G 23/18

(52) U.S. Cl. CPC G01G 19/4146; A47J 36/00; A47J 37/043; G01G 23/18

(57) ABSTRACT

A device for weighing portions of grilled food, a device for preparing food to be grilled, a method for preparing food to be grilled, and a computer program for implementing the method. The device for weight measurement for weighing portions of grilled food comprises a weighing device for measuring grilled food portions, wherein the weighing device includes a removal-weighing function and a portion-weighing function. The removal-weighing function determines the weight of grilled food proportions removed from a grilling device, while the portion-weighing function determines the weight of food portions created from the removed food proportions.

This nonprovisional application claims priority under 35 U.S.C. § 119 (a) to European Patent Application No. 24155317.1, which was on Feb. 1, 2024, and which is herein incorporated by reference.

### BACKGROUND OF THE INVENTION

### Field of the Invention

The present invention relates to a device for weight measurement for weighing portions of grilled food, a device for preparing food to be grilled, a method for preparing food to be grilled while performing weight controls, and a computer program for implementing the method.

### Description of the Background Art

The preparation of food through grilling has been known for millennia. In this process, the food to be prepared is exposed to the residual heat of a heat source without any closed element or additional container placed between the heat source and the food. Optionally, a grill grate may be configured to at least partially support the weight of the food while being positioned between the heat source and the food.

Grilling involves a cooking process for the food. Many grilling processes are focused on the preparation of meat as food; however, it is also known to grill fish, cheese, and/or vegetables. Furthermore, grilling of meat substitutes is not excluded.

Particularly in the preparation of meat through grilling, significant variations in the proportions of fat and/or water in the meat are observed due to industrial animal farming and meat processing practices.

During the grilling process, the applied heat reduces the viscosity of the fat, causing it to flow out of the meat. Water evaporates due to the heat input.

Consequently, there is a measurable weight difference between the theoretical quantity of available meat before grilling and the amount of meat prepared for consumption after grilling.

In the operation of grill restaurants, such as grill restaurants that are specializing in the preparation of Döner Kebab, a high throughput of grilled meat per unit of time is typically observed. However, the portioning of the meat quantities for each Döner Kebab is usually carried out manually, leading to inconsistencies in the quantity and weight of the served meat portions.

It is therefore desirable to be able to determine both the fat and water proportions of the meat and to monitor portion quantities.

### SUMMARY OF THE INVENTION

It is therefore an object of the present invention to provide a device for weight measurement for weighing portions of a grilled food, a device for preparation of a food to be grilled, a method for preparation of a food to be grilled with weight monitoring, as well as a computer program, which enable the weighing of component proportions of grilled food and the evaluation of corresponding measurement data.

This objective is achieved by the device for weight measurement for weighing portions of grilled food, by a device for preparing food to be grilled, by a method for preparing food to be grilled with weight monitoring, and by a computer program.

The invention provides a device for weight measurement for weighing portions of grilled food, which includes a weighing device for weighing the portions of grilled food. The weighing device features a removal-weighing function and a portion-weighing function. The removal-weighing function determines the weight of grilled food portions removed from a grilling device, and the portion-weighing function determines the weight of food portions created from the removed food proportions.

The food to be grilled or already grilled may, for example, be a spit of grilled meat, such as Döner Kebab. For the purposes of describing the present invention, it is assumed that such a meat spit may also contain other components, such as vegetables and/or dough-based products.

Grilled food proportions may be removed from a grilling device or grill station, which may be part of the device for measuring the weight of components of grilled food, for example, by gravitational force. For instance, meat components sliced from a kebab spit may fall downward due to gravity onto the weighing device with the removal-weighing function.

The device for weight measurement for weighing components of grilled food may be configured such that the weighing device for the removal-weighing function and the weighing device for the portion-weighing function are integrated into the same weighing scale.

In an example, the weighing device for the removal-weighing function may be a separate removal-scale, and the weighing device for the portion-weighing function may be a separate portion-scale. In this example, the weighing devices with removal-weighing and, the weighing devices with portion-weighing functions are distinct devices.

Each scale may be a food-safe and calibrated weighing scale, with a freely positionable weighing terminal and a detachable stainless steel platform.

The weighing device with the removal-weighing function may be designed to continuously or, whenever there is a change in the weight measured by the apparatus with the removal-weight function, intermittently determine a corresponding measurement value. Accordingly, the weighing device with the removal-weighing function can perform a measurement in the event of a recorded weight increase, for example, when meat is removed from a meat spit in the grill station, or when meat is taken from the weighing device with the removal-weighing function and transferred for sale. The weighing device with the removal-weighing function measures, accordingly, everything that is sliced or removed, for example, from a kebab spit and that is intended to be transferred for sale over a defined period of time, such as within a day. When the kebab spit is consumed, possibly leaving a residual portion, the weighing device with the removal-weighing function can determine how much meat from the kebab spit was ultimately transferred for sale. This allows conclusions to be drawn regarding the quality of the kebab spit and the amount of water and/or fat it contained.

The weighing device for the removal-weighing function may be configured to be positioned beneath the grilling device, so that portions of grilled food, separated or removed from the food arranged in the grilling device, fall onto the scale with the removal-weighing function, and can be weighed there.

Furthermore, the weighing device with the removal-weighing function may include a collection device for capturing water and/or fat dripping from the grilled food, and may be configured to weigh the captured water and/or fat.

The fat can also be picked up and weighed using the weighing device with the removal-weighing function, so that its proportion can also be determined.

The information regarding the actual quantity of obtained saleable food portions, or meat, also provides an indication of the proportion of food that is actually utilizable and the revenue generated from it in relation to the costs incurred for acquiring the food.

Furthermore, the weighing device with the removal-weighing function may be configured to measure and/or store the dwell time of the removed food proportions on the scale.

The weighing device with the removal-weighing function may be configured to transmit measurement data to a database or, via an internet interface, to a database or a cloud service with a database.

The removed food proportions weighed using the weighing device with the removal-weighing function can now be transferred in smaller quantities to the weighing device with the portion-weighing function to generate portions.

The weighing device with the portion-weighing function may be configured to display, on a display unit, a selection of available grilled food items and/or the weight of available grilled food items, and to allow the selection of a grilled food item desired by the customer and/or the weight of the grilled food item desired by the customer through the input of a control command.

Furthermore, the weighing device with the portion-weighing function may be configured to display a predefined portion weight of a grilled food item desired by the customer and, during the loading of the weighing device with the portion-weighing function, to display the remaining differential weight to be added. Alternatively, the weighing device with the portion-weighing function may be configured to display measurement values of the weighed food portions. This allows the person preparing the portions to adjust the portions to the exact intended weight. Accordingly, it ensures that the portioning of the goods is carried out as simply and economically as possible.

Furthermore, the weighing device with the portion-weighing function may be configured to store measurement values of the weighed food portions. The weighing device with the portion-weighing function may also be configured to transmit measurement data to a database or, via an internet interface, to a database or a cloud service with a database.

At the end of a defined time period, such as a day, it can be determined whether the weight of grilled food portions sold to customers via the weighing device with the portion-weighing function matches the weight of grilled food portions removed from the grilling device during the same time period. This weight can be determined by the weighing device with the removal-weighing function.

This allows verification of whether employees have bypassed the cash register to sell meat. Therefore, the presence of the weighing device with the removal-weighing function is advantageous for monitoring employee activities through the weighing device with the portion-weighing function.

The device for weight measurement for weighing portions of grilled food may also comprise a calculation unit for determining the difference between the weight of the food to be grilled before the grilling process and the total weight of the grilled food portions removed between a defined start event and a defined end event.

Alternatively, or additionally, the calculation device may also be configured to determine the difference between the total weight of the grilled food components removed and the total weight of the weighed food portions.

The weight of the food to be grilled before the grilling process, also referred to as the initial weight, may also be determined either by weighing or obtained from the manufacturer's specifications.

The time between the start event and the end event may be referred to as the product cycle. The start event may involve the input of a start signal, such as after hanging a new food item to be grilled into the grilling device.

The end event may involve the input of an end signal, such as after the complete conversion of the food to be grilled into removed grilled food components, or also upon reaching a non-usable residual portion of the food to be grilled in the grilling device.

The weight of the residual portion in the grilling device can also be measured using a scale, so that this residual weight can be included in the calculation of the difference between the weight of the removed grilled food components and the total weight of the weighed food portions.

The calculation unit may furthermore be configured to evaluate how many portions were sold per unit of time, such as per hour, per day, per month, or per year.

In an example, the calculation unit may be configured to generate corresponding sales statistics.

In an example of the device for measuring the weight of components of grilled food, the weighing device with the portion-weighing function comprises an information device for providing information to the user regarding the achievement of the intended portion weight.

This information device may, for example, be a signal light display with yellow light if the desired portion weight has not yet been reached, green light if the desired portion weight has been achieved, and/or red light if the desired portion weight has been exceeded.

Also, to the color display on the screen, an acoustic or optical signal, such as a flashing light or a sound, could be implemented to indicate when the desired portion weight or output weight has been exceeded.

Another aspect of the present invention is a device for preparing food to be grilled, comprising a grilling device and the described device for weight measurement for weighing portions of grilled food.

This device for preparing food to be grilled may also be referred to as a grilling system.

The grilling device used here is one in which the food to be grilled is at least partially grilled, and from which grilled, separated food portions are removed.

The invention also provides a method for preparing food to be grilled while performing weight controls, in which a described device for preparing food to be grilled is made available, the weight of the food to be grilled is determined, and the food to be grilled is at least partially grilled in the grilling device. Grilled food portions are separated from the food, removed from the grilling device, and transferred to a weighing device. Using a removal-weighing function of the weighing device, the weight of the removed grilled food components is determined, and using a portion-weighing function of the weighing device, the weight of food components created from the removed grilled food proportions is determined.

Like the described device for weight measurement for weighing portions of grilled food, the present method for preparing food to be grilled while performing weight controls can also carry out these weight controls during the preparation of döner kebab meat.

The weight of the food to be grilled before the grilling process, also referred to as the initial weight, may also be determined either by weighing or obtained from the manufacturer's specifications.

Removed grilled food proportions shall be understood as food portions that, after being separated in the grilling station or grilling device, have moved out of it and are thus located outside the area covered by a heating element of the grilling device.

All measurement data obtained from the weighing functions can be stored and/or processed for analysis, allowing determination of how much, or what weight, of grilled food proportions is made available from a food item to be grilled, as well as the magnitude of the weight difference resulting from the loss or evaporation of water and/or fat that is no longer present in the grilled food portions.

Furthermore, it can be determined whether all grilled food portions were actually entered into the recorded sales and the proportion of unrecorded sales.

The method is explained below using the example of a kebab spit and its preparation.

The weight of a new kebab spit to be grilled is recorded. The kebab spit is placed into a grilling device.

Through the known grilling process, a portion of the meat on the kebab spit is cooked or grilled. This portion is separated from the kebab spit, removed from the grilling device, and rests on the weighing device with the removal-weighing function for measurement and further processing.

The weighing device with the removal-weighing function can continuously measure the weight of the meat present on it or alternatively measure upon any change in weight, or else only upon a weight increase by a defined differential amount, such as 500 g.

Grilled meat removed by the weighing device with the removal-weighing function is taken over by the weighing device with the portion-weighing function until a desired portion weight is reached on the weighing device with the portion-weighing function.

The weighing device with the portion-weighing function and/or the weighing device with the removal-weighing function thereby transmits the respective measurement values to a database.

Any meat from the kebab spit that is no longer usable, such as 10-15% of the initial meat quantity, can be cut from the spit and weighed using the weighing device with the portion-weighing function. Optionally, for evidence purposes, a photo of the remaining meat together with the measured residual weight can be stored.

If the weight of the remaining meat is too large to be weighed using the weighing device with the portion-weighing function, it is also possible to weigh the remaining meat using the weighing device with the removal-weighing function and input the weight value into the weighing device with the portion-weighing function.

Furthermore, the present invention comprises a computer program that can be loaded into the internal, particularly non-volatile, memory of a digital computer, in particular a smartphone or a tablet computer, and comprises computer program code which, when executed on the digital computer, performs the following steps: receiving a value for the weight of the food to be grilled; receiving values for the weight of removed grilled food proportions; receiving weight values of food portions created from the removed grilled food proportions, wherein the weight values of the removed grilled food proportions and the created food portions are determined in accordance with the presented method for preparing food to be grilled while performing weight controls; calculation of a first differential weight between the weight of the food to be grilled and the sum of the weights of the removed food proportions, as well as transmission of the corresponding data to an output device; and/or calculation of a second differential weight between the sum of the weights of the removed food proportions and the sum of the food portions created from the removed food proportions, as well as transmission of the corresponding data to an output device.

The information regarding the initial weight of the food to be grilled, or the meat spit, can be transmitted to the database along with a timestamp. This input can represent the start of a new product cycle.

The computer program may be configured to initiate the display of a graphical user interface on a display, wherein the user interface comprises a graphical representation designed to receive weight values and output calculated differential weights. The information regarding the initial weight and residual weight of a product unit is recorded in the database along with corresponding timestamps.

Each database used links a respective product unit, in the form of the food to be grilled, with the weighing device or multiple weighing devices.

The computer program further allows the creation of multiple product groups in the system memory, for example, organized by reference weight, waste, and similar categories.

The computer program may be configured to initiate the weighing process via the weighing device with the portion-weighing function through the selection of the product or a defined product group. The weight of the respective portion, as measured by the weighing device with the portion-weighing function, is then transmitted to the database along with a timestamp.

In the database, the measurement values and information obtained from the weighing device with the removal-weighing function and the weighing device with the portion-weighing function can be stored together in a combined manner or, if necessary, separately, from where they can be retrieved for analysis either jointly or individually.

This enables the straightforward creation of weekly, monthly, and/or yearly statistics, which can serve as a basis for operational business decisions.

Additionally, it facilitates the simple calculation of waste quantities and shrinkage over time.

The present invention, however, is not limited to the combination of the weighing device with the removal-weighing function and the weighing device with the portion-weighing function. It is also possible to use only the weighing device with the removal-weighing function, providing the advantage of determining the weight difference between the food to be grilled in its initial state and the sum of the grilled, removed food proportions.

In an example, the weighing device with the portion-weighing function can also be used independently, providing the advantage that, assuming the amount or weight of the sum of the removed food proportions is known, it becomes possible to monitor how much grilled food actually reaches the point of sale.

Thus, a device for weight measurement for weighing portions of a grilled food item is also provided, which includes a weighing device for weighing grilled food portions, wherein the weighing device comprises a removal-weighing function, and the removal-weighing function determines the weight of grilled food portions removed from a grilling device.

The weighing device with the removal-weighing function may be configured to continuously or, with every change in the weight measured by the weighing device with the removal-weighing function, determine a corresponding measurement value.

Furthermore, the weighing device with the removal-weighing function may include a collection unit for capturing water and/or fat dripping from the grilled food and may be configured to weigh the captured water and/or fat.

Additionally, the weighing device with the removal-weighing function may include a calculation device configured to calculate, between a defined start event and a defined end event, the difference between the weight of the food to be grilled before the grilling process and the sum of the weights of the removed grilled food proportions.

Another aspect of the weighing device with the removal-weighing function is a device for preparing food to be grilled, comprising a grilling device and a device for measuring the weight of portions of a grilled food item, wherein the weight measurements are carried out using the weighing device with the removal-weighing function.

The grilling device used herein is one in which the food to be grilled is at least partially grilled and from which grilled, separated proportions of the food are removed.

The weighing device with the removal-weighing function facilitates the execution of a method for preparing food to be grilled while performing weight controls, wherein the aforementioned device for preparing food to be grilled is provided, the weight of the food to be grilled is determined, the food to be grilled is at least partially grilled in the grilling device, grilled portions of the food are separated from the food, removed from the grilling device, and transferred to a weighing device, and the weight of the removed food proportions is determined using the removal-weighing function of the weighing device.

Additionally, a computer program, particularly an app, can also be provided, which can be loaded into the internal, especially non-volatile, memory of a digital computer, such as a smartphone or a tablet computer, and which comprises computer program code that, when executed on the digital computer, performs the following steps: receiving a value for the weight of the food to be grilled; receiving values for the weight of removed grilled food proportions, wherein the weight values of the removed food proportions are determined according to the described method using the removal-weighing function; and/or calculation of a first differential weight between the weight of the food to be grilled and the sum of the weights of the removed food proportions, as well as transmission of the corresponding data to an output device.

This computer program may be configured to initiate the display of a graphical user interface on a screen, wherein the user interface includes a graphical representation designed to receive weight values and output calculated differential weights.

Alternatively, a device for measuring the weight of portions of a grilled food item is provided, comprising a weighing device for weighing grilled food portions, wherein the weighing device includes a portion-weighing function, and the portion-weighing function determines the weight of food portions created from grilled food portions removed from a grilling device.

It may be provided that the weighing device with the portion-weighing function is configured to display a selection of available grilled food items on a display unit and/or display the weight of available grilled food items, and, through the input of a control command, allow the selection of a grilled food item desired by the customer and/or the selection of the weight of the grilled food item desired by the customer.

Furthermore, the weighing device with the portion-weighing function may be configured to display a predefined portion weight of a grilled food item desired by a customer, and, during the loading of the weighing device with the portion-weighing function, display the remaining differential weight to be added. Or, the weighing device with the portion-weighing function may be configured to display the measurement values of the weighed food portions.

Alternatively or additionally, the weighing device with the portion-weighing function may be configured to store the measurement values of the weighed food portions.

The weighing device with the portion-weighing function may also include a calculation device configured to calculate, between a defined start event and a defined end event, the difference between the weight of the sum of the removed grilled food proportions and the sum of the weighed food portions.

Furthermore, the weighing device with the portion-weighing function may include an information device for providing information to the user regarding the achievement of the intended portion weight.

An additional aspect of the weighing device with the portion-weighing function is a device for preparing food to be grilled, which includes a grilling device as well as a device for measuring the weight of portions of food to be grilled, wherein the weight measurements are performed using the weighing device with the portion-weighing function.

The grilling device used here is one in which the food to be grilled is at least partially grilled and from which grilled, separated portions of the food are removed.

The weighing device with the portion-weighing function enables the execution of a method for preparing food to be grilled while performing weight controls, wherein the aforementioned device for preparing food to be grilled is provided, the food to be grilled is at least partially grilled in a grilling device, grilled food proportions are separated from the food and removed from the grilling device, the weight of the removed grilled food proportions is determined, and the weight of food portions created from the removed grilled food proportions is determined using the portion-weighing function of the weighing device.

Accordingly, a computer program, particularly an app, may be provided to collaborate with the weighing device with the portion-weighing function. This program can be loaded into the internal, especially non-volatile, memory of a digital computer, such as a smartphone or tablet computer, and includes computer program code that, when executed on the digital computer, performs the following steps: receiving weight values of the removed grilled food proportions; receiving weight values of food portions created from the removed grilled food proportions, wherein the weight values of the created food portions are determined using the portion-weighing function according to the described method; and/or calculating a second differential weight between the sum of the weights of the removed food proportions and the sum of the weights of the food portions created from the removed food proportions, as well as transmitting the corresponding data to an output device.

This computer program may be configured to initiate the display of a graphical user interface on a screen, wherein the user interface includes a graphical representation designed to receive weight values and output calculated differential weights.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a device for preparing food to be grilled, shown prior to the removal of food proportions;

FIG. 2 is a schematic representation of a device for preparing food to be grilled, shown during the removal of food proportions;

FIG. 3 is a schematic representation of a device for preparing food to be grilled, shown during the weighing of removed food proportions;

FIG. 4 is a schematic representation of an example of the weighing device with a display unit;

FIG. 5 is a schematic representation of an example of the weighing device with an information device and a calculation device; and

FIG. 6 is a further schematic representation of an example of the weighing device with a database and a calculation device.

### DETAILED DESCRIPTION

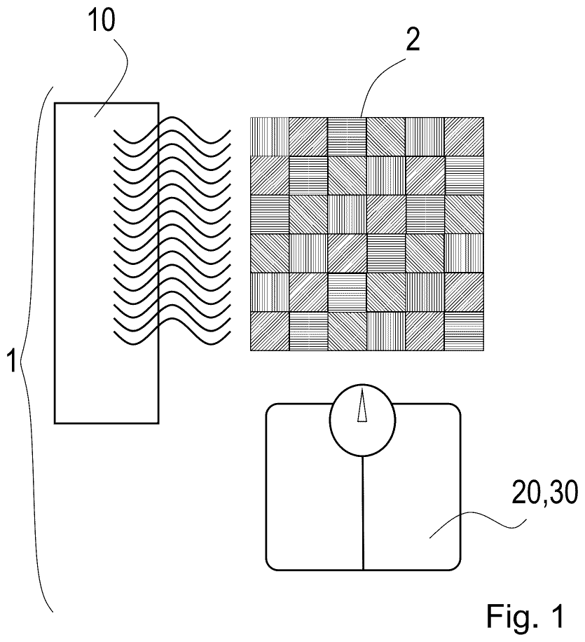

First, the basic structure and fundamental functionality of an example of the device for preparing food to be grilled (1), and thereby also the device for measuring the weight of portions of a grilled food, shall be explained using FIGS. 1-3.

The device for preparing food to be grilled (1) comprises a grilling device (10), which may also be referred to as a grill station. The residual heat from this grilling device (10) acts on the food to be grilled (2), such as a Döner kebab spit. This food to be grilled (2) is thereby cooked and prepared. Beneath the food to be grilled (2), a device for weight measurement (20) is located in the form of a weighing device for the removal-weighing function (30).

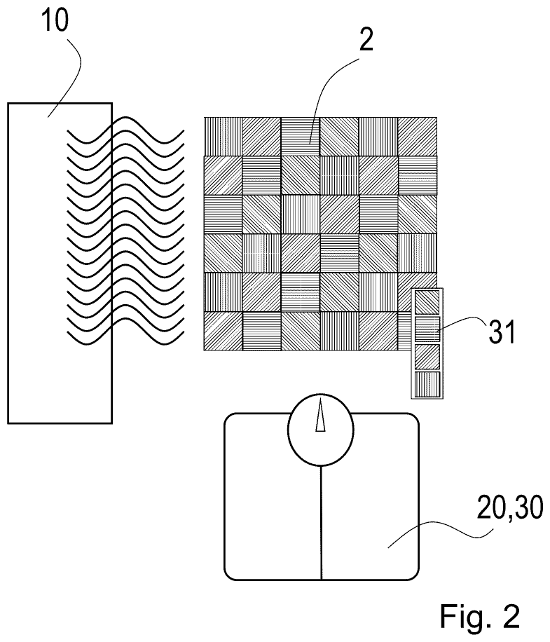

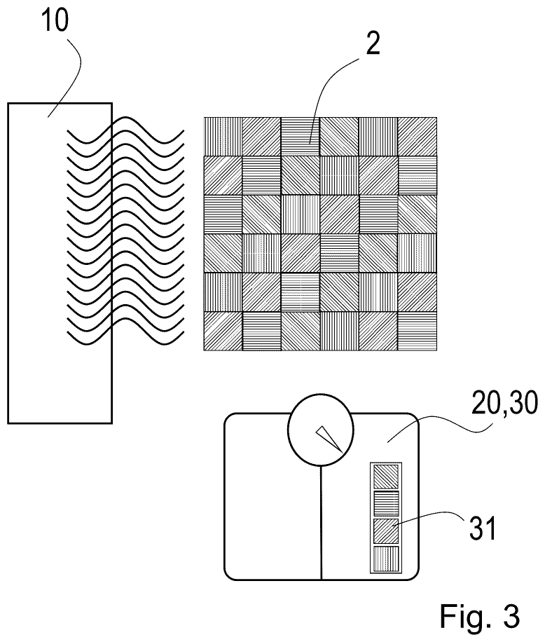

When the food to be grilled (2) is sufficiently cooked, proportions of food are cut from its surface and removed from the grilling device (10), as indicated in FIG. 2. These cut food portions are referred to as the removed food proportions (31). These removed food proportions (31) fall, due to gravity, onto the weighing device for the removal-weighing function (30), as shown in FIG. 3. The weighing device for the removal-weighing function (30) weighs the removed food proportions (31), either upon each recorded weight increase or alternatively upon any change in the weight value detected by the weighing device for the removal-weighing function (30).

The measurement values can be made available to a data storage or an evaluation unit.

The total weight of the removed food proportions (31) can be determined and compared to the weight of the uncooked food to be grilled (2) measured prior to the grilling process.

This allows for determining whether and how much weight loss occurred during the grilling process, particularly due to the evaporation of water and/or the draining of heated fat.

Optionally, the weighing device for the removal-weighing function (30) may be also equipped with a collection container for heated fat, enabling the exact determination of the amount of drained fat.

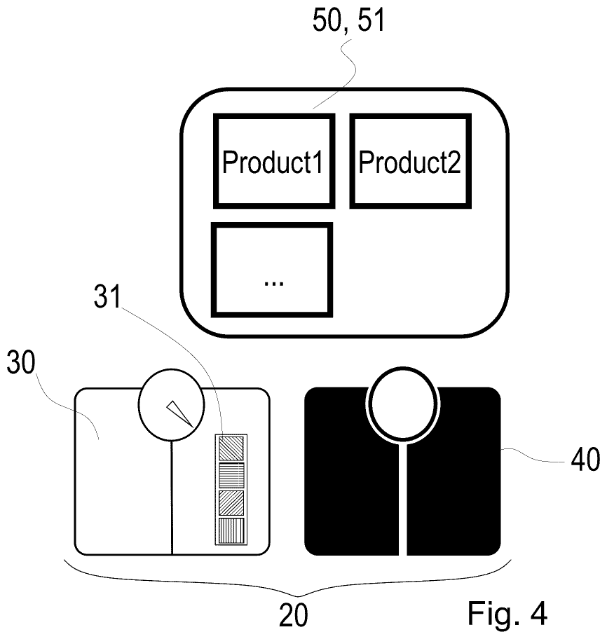

FIG. 4 illustrates that the device for weight measurement (20) may further comprise a weighing device for the portion-weighing function (40). Additionally, a display unit (50) may be included, which can display available dishes or products and/or their weights. This display unit (50) may optionally also function as an input unit (51), enabling the user to select a displayed dish or product and/or its weight by entering a command.

In this way, the associated food weight can be displayed by showing and selecting a specific product.

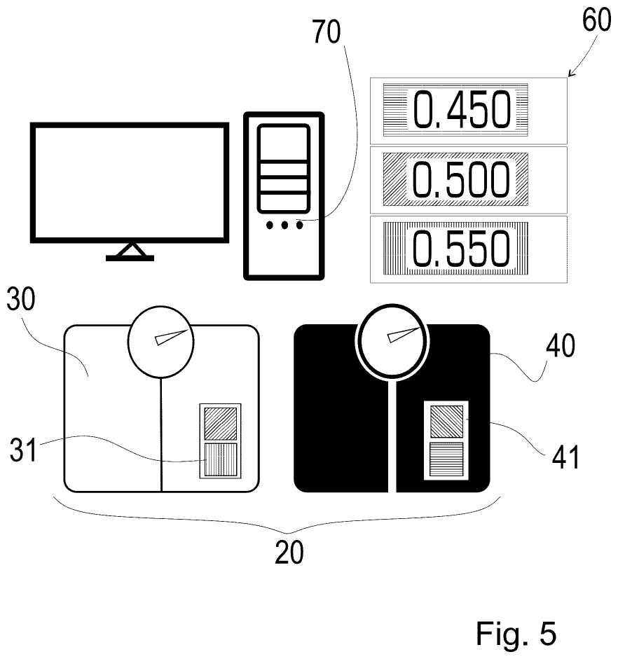

As illustrated in FIG. 5, the removed food proportions (31) from the weighing device for the removal-weighing function (30) can now be partially taken over by the weighing device for the portion-weighing function (40) as food portions (41).

This takeover process can continue until the selected product's food weight has been reached. For this purpose, the information device (60) supports the process by signaling, as exemplified by the three displays, using different display colors to indicate whether the target weight of the desired portion is below, exactly reached, or exceeded.

It can thus be determined what weight each food portion (41), which was sold, actually had.

Using a connected calculation device (70), appropriate difference values can be calculated and, if necessary, processed into statistics.

Through the illustrated combination of the weighing device for the removal-weighing function (30) with the weighing device for the portion-weighing function (40), it can thus be determined how much of the originally intended food to be grilled (2) was actually made available, how much of it was actually sold, and in what portion sizes.

It is not excluded that the device for weight measurement (20) comprises only one weighing device, either for the removal-weighing function (30) or for the portion-weighing function (40).

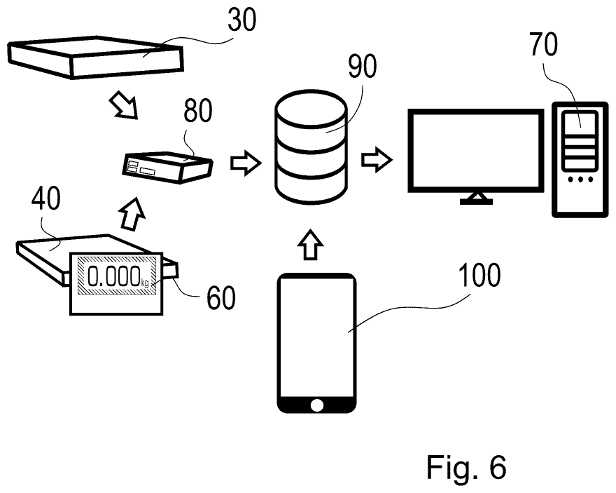

FIG. 6 illustrates an example of the weighing device with a database and calculation unit. The weighing device for the removal-weighing function (30) and the weighing device for the portion-weighing function (40) are depicted once again, wherein the weighing device for the portion-weighing function (40) is equipped with an information device (60) to provide the user with information regarding the achievement of the intended portion weight. Measurement values from the weighing devices (30, 40) can be transmitted to a database (90) via an internet interface (80). From the database (90), these measurement values or data can then be transmitted to a calculation device (70) for evaluation and the creation of appropriate statistics. The database (90) can also interact with a mobile device (100) equipped with a corresponding app, which, for example, enables the input of the weight of the food to be grilled (2) before the grilling process and contributes to the calculation of difference values between the sum of the removed food proportions and the initial weight.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for weight measurement (20) for weighing proportions of grilled food, comprising a weighing device for measuring grilled food proportions, wherein the weighing device includes a removal-weighing function and a portion-weighing function, the removal-weighing function being configured to determine the weight of grilled food portions (31) removed from a grilling device, and the portion-weighing function being configured to determine the weight of food portions (41) created from the removed food proportions.

2. The device for weight measurement for weighing portions of grilled food according to claim 1, wherein a weighing device for the removal-weighing function and a weighing device for the portion-weighing function are configured within the same scale.

3. The device for weight measurement for weighing portions of grilled food according to claim 1, wherein the weighing device for the removal-weighing function (30) is a removal scale, and the weighing device for the portion-weighing function (40) is a portion scale, wherein the removal scale is distinct from the portion scale.

4. The device for weight measurement for weighing portions of grilled food according to claim 1, wherein the weighing device for the removal-weighing function (30) is configured to continuously, or upon any change in the weight measured by the weighing device for the removal-weighing function (30), determine a corresponding measurement value.

5. The device for weight measurement for weighing portions of grilled food according to claim 1, wherein the weighing device for the removal-weighing function (30) includes a collection device for collecting water and/or fat draining from the grilled food, and is configured to weigh the collected water and/or fat.

6. The device for weight measurement for weighing portions of grilled food according to claim 1, wherein the weighing device for the portion-weighing function (40) is configured to display, on a display unit (50), a selection of available grilled food items and/or the weight of available grilled food items, and to enable the selection of a grilled food item desired by the customer and/or the weight of the grilled food item desired by the customer through the input of a control command.

7. The device for weight measurement for weighing portions of grilled food according to claim 1, wherein the weighing device for the portion-weighing function (40) is configured to display a predefined portion weight of a grilled food item desired by a customer and, during the loading of the weighing device for the portion-weighing function (40), to display the remaining differential weight to be added, or that the weighing device for the portion-weighing function (40) is configured to display measurement values of the weighed food portions (41).

8. The device for weight measurement for weighing portions of grilled food according to claim 1, wherein the weighing device for the portion-weighing function (40) is configured to store measurement values of the weighed food portions (41).

9. The device for weight measurement for weighing portions of grilled food according to claim 1, wherein the device for weight measurement for weighing portions of grilled food comprises a calculation device (70) configured to calculate, between a defined start event and a defined end event:
i) the difference between the weight of the food to be grilled (2) before the grilling process and the weight of the sum of the grilled removed food proportions (31); and/or
ii) the difference between the weight of the sum of the grilled removed food proportions (31) and the sum of the weighed food portions (41).

10. The device for weight measurement for weighing portions of grilled food according to claim 1, wherein the weighing device for the portion-weighing function (40) comprises an information device (60) configured to provide information to the user regarding the achievement of the intended portion weight.

11. A device for preparing food to be grilled, the device comprising:
a grill; and
the device for weight measurement for weighing portions of grilled food according to claim 1.

12. A method for preparing food to be grilled with the execution of weight controls, the method comprising:
providing the device for preparing food to be grilled according to claim 11;
determining a weight of the food to be grilled;
at least partially grilling the food to be grilled in the grilling device;
separating grilled food portions from the food, removing the separated grilled food portions from the grilling device, and transferring the removed grilled food portions to a weighing device for the removal-weighing function;
determining a weight of the removed food proportions using the weighing device for the removal-weighing function; and
determining the weight of food portions created from the removed food proportions using the weighing device for the portion-weighing function.

13. A computer program that adapted to be loaded into an internal, in particular non-volatile, memory of a digital computer or a smartphone or a tablet computer, the computer program comprising computer program code which, when executed on the digital computer, smartphone, or tablet computer performs the following steps:
receiving a value of the weight of the food to be grilled;
receiving values of the weight of grilled removed food portions;
receiving values of the weight of food portions created from grilled removed food portions, the weight values of the removed food proportions and the created food portions being determined according to the method of claim 12;
calculating a first weight difference between the weight of the food to be grilled and a sum of the weights of the removed food proportions, sending a corresponding data to an output device; and
calculating a second weight difference between the sum of the weights of the removed food proportions and the sum of the food portions created from the removed food proportions, and sending the corresponding data to an output device.

14. The computer program according to claim 13, further comprising initiating a display of a graphical user interface on a display, wherein the graphical user interface comprises a graphical representation suitable for receiving the weight values and outputting the calculated weight differences.
